(19) United States
(12) Patent Application Publication
(10) Pub. No.: US 2009/0180163 A1
(43) Pub. Date: Jul. 16, 2009

(54) PRINT SCANNER WITH JAM DETECTION SYSTEM AND METHOD

(76) Inventor: David J. Cornell, Scottsville, NY (US)

Correspondence Address: David A. Novais;Patent Legal Staff, Eastman Kodak Company, 343 State Street, Rochester, NY, 14650-2201, US

(21) Appl. No.: 12/015,155

(22) Filed: Jan. 16, 2008

(51) Int. Cl. H04N 1/04

(52) U.S. Cl. 358/498

(57) ABSTRACT

A print scanner with jam detection system including a scanning module mounted in a body, such that the scanning module scans in a capture zone to capture an archival image of said capture zone as well as one or more non-archival images. One or more image capture modules mounted in the body in fixed relation to the capture zone being operative to capture a stream of the non-archival images in the capture zone.

### FIELD OF THE INVENTION

The invention relates to a printer having a scanner and more particularly relates to a scanner with one or more image capture modules being operative to include a jam detection system and related method.

### BACKGROUND OF THE INVENTION

Document scanners have become a popular computing accessory both in the home and the office. Essentially, document scanners (or simply “scanners”) come in three distinct varieties: sheet-fed scanners, platen scanners and scanners having a rigid combination of sheet-fed and platen scanning capabilities. With respect to sheet-fed scanners, an image-forming subsystem, such as a camera, typically including a linear imaging sensor and a lens in combination with an illumination source, scans an image by moving a sheet of paper past the sensor, which sits in a stationary position. The documents are fed from a stack and are passed through a paper path disposed at the field of view of the sensor. As each document passes in front of the sensor individual raster lines are imaged by the imaging device and then pieced together to create a 2D image representation of the original document. The imaging device captures the width of the image, line by line, while the document is moved past the sensor.

With respect to platen scanners, a document is placed face down onto a stationary flat transparent surface of the scanner and the image-forming subsystem and illumination source, moves underneath the fixed document to perform the scanning operation. In this case, the imaging device is moved the length of the document while the optics covers the width of the scanned document. The platen scanner requires lifting a lid and placing document sheets face down one at a time. The platen capability is also employed to deal with documents that do not feed from a stack reliably.

Scanners vary in speed, function, and cost and are often used by businesses for scanning large quantities of documents. The demand for scanning at a given installation can be as high as from several hundred (100) to several hundred thousand (100,000) pages per day. Sheet-fed scanners offer greatest productivity by employing an imaging system on both sides of the paper path, imaging both the front and back of each document during the same scanning operation. One type of production scanner attempts to combine the functionality of a sheet-fed scanner with that of a platen scanner. Essentially, such combination production scanners are manufactured as a single unit that combine the platen scanning functions with the sheet moving functions in a single box.

With prior sheet-fed, platen, or combination scanners, the user must select one type in favor of another. For those customers whose primary need is for a sheet-fed scanner but who occasionally need the platen utility, they must purchase a combination device or two separate scanners (one sheet-fed and one platen). Purchasing both types of scanning devices may be cost prohibitive or impossible and, in either case, impractical for applications where portability is desired. For example, a scanning service provider may require the ability to carry the scanner and host computer in order to transport both systems to a remote jobsite. After the job is finished, the scanner and computer must be brought back to the service bureau headquarters or to the next jobsite. One task may require scanning a large number of similar documents, suited to the sheet-fed scanner and not requiring a platen. The next task at the next site may require scanning fragile documents or books, requiring the use of a platen. Thus, portability and the ability to reconfigure and perform multiple scanning functions are critical to people who buy scanners to scan documents as a service.

Typically flat bed scanners are configured as desktop computer peripheral devices and therefore they incorporate various data communication, control and power conversion structures suitable for such use. Some scanners of this type can operate independently from the computer when used as a component for an “all-in-one” device also incorporating a printer and modem to provide copying and faxing capabilities. However, scanners of this type typically do not include portable power supplies and have no removable memory storage capabilities when not connected to a computer.

Print scanners come in various sizes to accommodate different sizes of “flat art” including images, documents, artwork, and the like. When scanning documents that are larger that the scan aperture, it is known to use “digital stitching algorithms” to combine multiple overlapping sections of an image into a complete seamless digital image. Because many images are recorded on tangible mediums that are stored in photo albums with image bearing mediums adhered to pages with many different techniques using glues, adhesives, and tapes, removal of these image bearing mediums from the photo albums would be labor intensive, time consuming, and could subject fragile, one of a kind, images to potential damage. Since photo albums typically are formed by bound pages it would not be possible to scan these pages with a smaller format scanner with an incorporated print feed mechanism. In addition, when attempting to scan bound albums with a typical flat bed scanner, damage to the binder, binding means, and/or book spine could occur when pressing an opened album against the scan aperture. Finally, transporting a large format document scanner, that is not capable of operating independently from a computer, to an event such as a family holiday celebration in order to copy images from a bound photo album would be difficult if not impractical.

Another problem with such flat bed scanning systems and other known scanning devices for scanning a document having an image recorded thereon is that such systems are often difficult to operate, are non-intuitive and when jams occur they are difficult to detect early and correct without damaging the document that is jammed in the machine. This is becoming so important because scanners are increasingly being used to digitize old, fragile and rare documents that are often fragile but to do so one at a time is unpractical so a feeder is often necessary increasing the opportunities for jams to occur and increasing the difficulty in detection and correction.

It is desirable to have a scanner system and related methods of scanning that correct these problems. A scanner having a scanning module that is actuatable to translate along said platen and scan a capture zone to capture an archival image of said capture zone in real time and position in conjunction with one or more image capture modules mounted in said body in fixed relation to said capture zone, said one or more image capture modules being operative to capture a stream of non-archival images of said capture zone in order to detect and correct a jam.

### SUMMARY OF THE INVENTION

The invention is defined by the claims. The invention, in broader aspects, provides a body, a transparent platen mounted to said body, said platen defining a capture zone adjoining said platen external to said body, a scanning module mounted in said body, said scanning module being actuatable to translate along said platen and scan said capture zone to capture an archival image of said capture zone and one or more image capture modules mounted in said body in fixed relation to said capture zone, said one or more image capture modules being operative to capture a stream of non-archival images of said capture zone in order to detect and correct a jam.

### BRIEF DESCRIPTION OF THE DRAWINGS

The invention and its objects and advantages will become apparent upon reading the following detailed description and upon reference to the drawings.

FIGS. 1-3 are perspective views of a prior art sheet-fed, platen, and combination scanners.

FIGS. 4 is a perspective view of a print scanner with jam detection system according to the present invention.

FIG. 5 is a schematic side view, showing details of the internal mechanisms of the print scanner with jam detection system.

FIG. 6 shows a portion of an embodiment of a print scanner with jam detection system.

FIG. 7 is another embodiment of the jam detection system.

FIG. 8 shows the steps for a method of using the scanning system.

FIG. 9 shows a portion of the viewer.

FIG. 10 shows the steps for a method of using the print scanner with jam detection system.

### DETAILED DESCRIPTION OF THE INVENTION

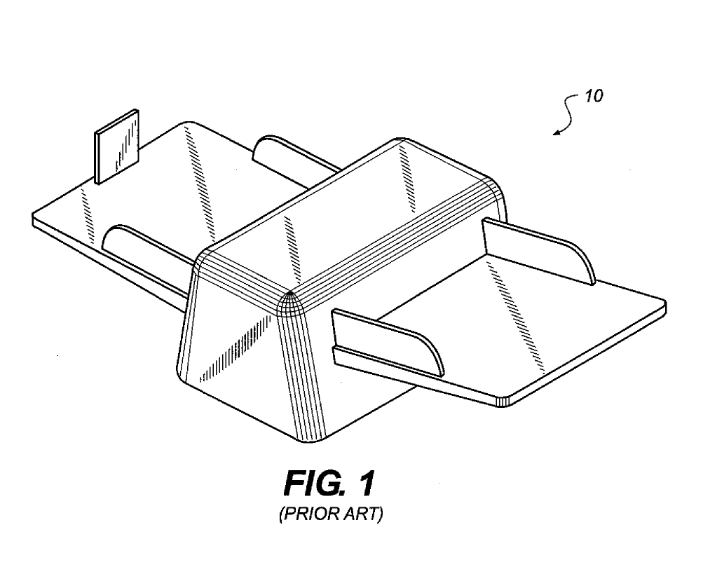

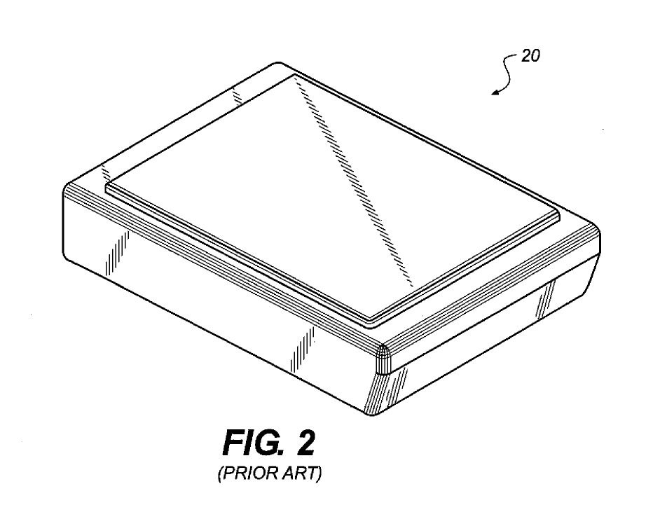

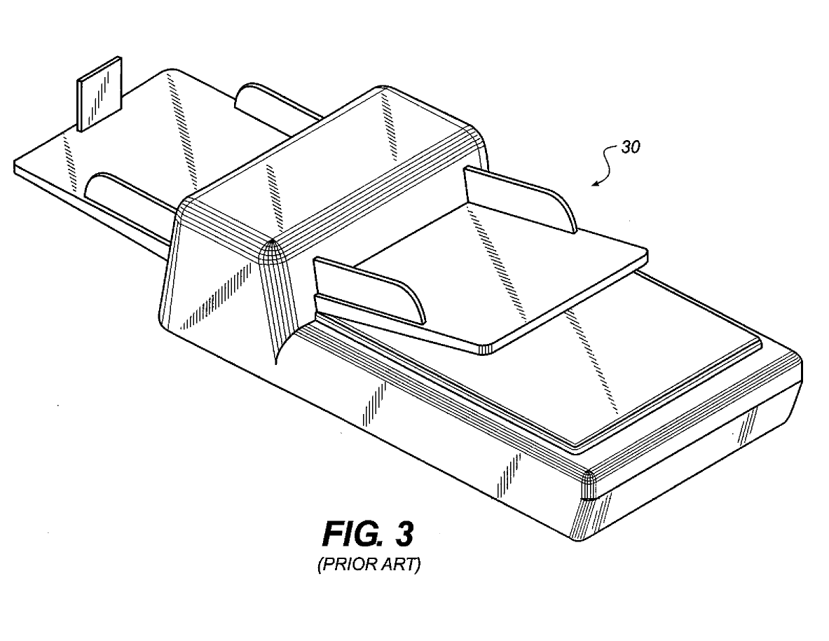

Essentially, document scanners (or simply “scanners”) come in three distinct varieties: sheet-fed scanners 10 as shown in FIG. 1, platen scanners 20 shown in FIG. 2, and scanners 30 having a rigid combination of sheet-fed and platen scanning capabilities shown in FIG. 3. With respect to sheet-fed scanners 10, an image-forming subsystem, such as a printer, camera, phone and entertainment device, typically including a linear imaging sensor and a lens in combination with an illumination source, scans an image by moving a sheet of paper past the sensor, which sits in a stationary position. The documents are fed from a stack and are passed through a paper path disposed at the field of view of the sensor. As each document passes in front of the sensor individual raster lines are imaged by the imaging device and then pieced together to create a 2D image representation of the original document. The imaging device captures the width of the image, line by line, while the document is moved past the sensor.

With respect to platen scanners 20, a document is placed face down onto a stationary flat transparent surface of the scanning unit and the image-forming subsystem and illumination source, moves underneath the fixed document to perform the scanning operation. In this case, the device is moved the length of the document while the optics cover the width of the scanned document. The platen scanner requires lifting a lid and placing document sheets face down one at a time. The platen capability is also employed to deal with documents that do not feed from a stack reliably.

Scanners vary in speed, function, and cost and are often used by businesses for scanning large quantities of documents. The demand for scanning at a given installation can be as high as from several hundred (100) to several hundred thousand (100,000) pages per day. Sheet-fed scanners offer greatest productivity by employing an imaging system on both sides of the paper path, imaging both the front and back of each document during the same scanning operation. One type of production scanner 30 attempts to combine the functionality of a sheet-fed scanner with that of a platen scanner. Essentially, such combination production scanners are manufactured as a single unit that combine the platen scanning functions with the sheet moving functions in a single box.

With prior sheet-fed, platen, or combination scanners, the user must select one type in favor of another. For those customers whose primary need is for a sheet-fed scanner but who occasionally need the platen utility, they must purchase a combination device or two separate scanners (one sheet-fed and one platen). Purchasing both types of scanning devices may be cost prohibitive or impossible and, in either case, impractical for applications where portability is desired. For example, a scanning service provider may require the ability to carry the scanner and host computer in order to transport both systems to a remote jobsite. After the job is finished, the scanner and computer must be brought back to the service bureau headquarters or to the next jobsite. One task may require scanning a large number of similar documents, suited to the sheet-fed scanner and not requiring a platen. The next task at the next site may require scanning fragile documents or books, requiring the use of a platen. Thus, portability and the ability to reconfigure and perform multiple scanning functions are critical to people who buy scanners to scan documents as a service. All of these are susceptible to jams of the original documents and/or the receivers.

Some scanning technology uses low resolution previews, often at a high speed but if part of the document is not physically in the scanned area or one item is covering an important section of another, the items must be physically reconfigured and another scan must be attempted. It is difficult to work with in a number of situations where the documents may move or be at a wrong angle. These difficult situations are becoming much more common in these days of speed scanning. Prior art scanners that have a preview function do not actually show you the preview in real time at all because the scanner must preview the image first which takes a period of time and then the user can view an image as it was but not as it is when the scanning when the jam occurred.

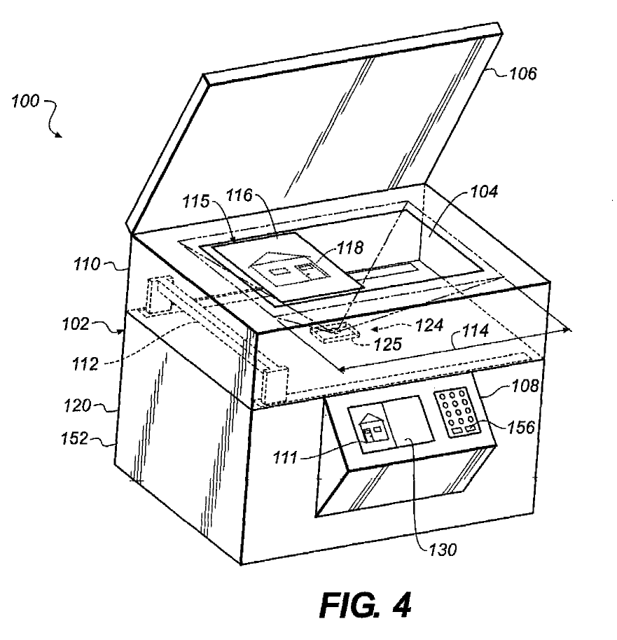

FIG. 4 shows a print scanner with jam detection system 100 and related methods of jam detection that can solve these problems. The print scanner with jam detection system 100 includes a body 102, a platen 104 held by the body 102, and an optional lid 106. The system 100 has an image viewing module 108 mounted on the body as well as a scanning module 110 mounted below the platen. The scanning module 110 has an image forming subsystem, such as a linear imager 112. The linear imager being translatable relative to the platen 104 wherein, in this embodiment, the platen defines a capture zone 114. If an item or items 115, such as a document 116 having an image 118, are scanned and portions of the item are not positioned properly or portions are out of the scanning area then the item(s) can be viewed real time or as a non-archival image 111 and can be repositioned with the scanner system 100 prior to printing by a printing engine 120. With prior art scanners this was very difficult to complete and nearly impossible to get correct with out an extensive time-consuming iterative process repeated over and over which was time consuming. The print scanner with jam detection system 100 solves this problem and is very useful for scanning especially difficult to scan items, such as scanning multiple small items such as receipts or creating a collage of images/documents and getting it right the first time without the worries that a jam can produce.

### Scanning Unit

The scanning unit 110, also referred to as a scanning module, is located in the upper portion of the body 102, also referred to as a housing or cabinet that can house the upper scanning module 110 and the lower printer engine or module 120. The upper portion of the body 102 includes the platen 104 shown here as a transparent (e.g. glass) plate upon which the item 115, such as a document 116 having the image 118 as shown in FIG. 4, is placed in a face-down position. The glass platen 104 is where documents will be placed in relation to an imaging capture module 124 having an image capture device 125 such as a CCD, is provided in association with platen 104 for capturing of images on documents.

The lower portion of the body 102 encloses the lower printer engine or module 120 that houses the mechanisms necessary to effect platen scanning. It is known that these modules could be arranged in other configurations that are known in the art to cooperate to scan and print an item. In this embodiment, the glass top or platen 104 provides the place where documents to be scanned are placed. The optional lid 106 allows covering of the documents to be scanned, and limits the outside influence of lights, which would interfere with proper scanning of a document as well as helps to hold any item flat against platen 104. The lid 106 is attached by a hinge or in another appropriate manner or may be just a lift able separate part.

The scanner provides a housing for the various components, devices, subsystems, and other mechanisms necessary to effectuate scanning of documents. Prior to scanning, the lid 106 may be closed to provide the proper lighting, background, and paper constraint conditions for the image-forming subsystem 112 and, in particular, to permit the optical system, including any lens, to receive adequate light reflections of images appearing on documents placed on platen 104. The scanning unit 110 includes a set of mechanisms for enabling complete platen scanning of documents in operable combination with the control and image processing functions. The platen element includes an enclosure having a top surface with a glass top attached thereon. The platen element can include a lid with a substantially flat surface suitable for covering documents placed on the glass top. The lid can be opened and closed with a hinging means that couples the lid to the enclosure.

Most commonly the print scanner with jam detection system 100 includes a sheet-fed scanner, as shown in FIG. 3, which can be an independent device or alone in the manner that will be described below. The sheet-fed scanner contains the same subsystems plus additional systems for communicating to a host computer, the hardware and firmware for processing and transmitting the images, motion controllers, etc. The sheet-fed scanner contains all the subsystems that are shared by both elements as well as those unique to the sheet-fed functionality.

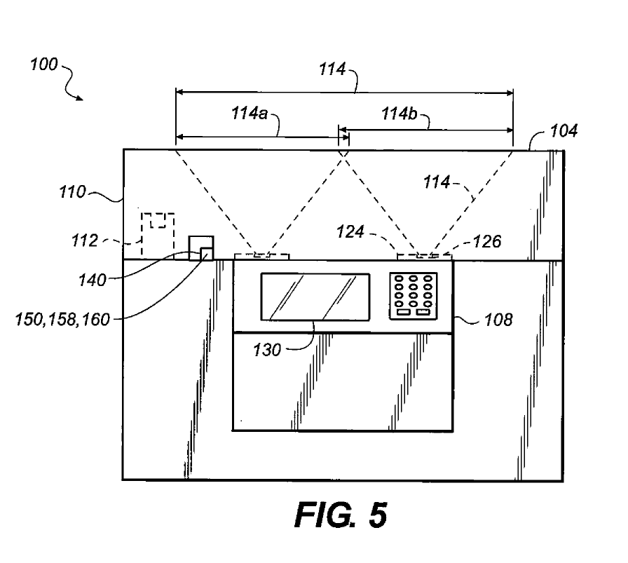

As shown in FIG. 4, the present invention the scanning module 110 has the image capture device or image detector, shown here as the image capture module 124, which could include one or more cameras. This additional image detector is shown here as a live active camera (or cameras), is placed in the body of the scanner to output to a display screen 130, such as an LCD screen, as part of the image-viewing module 108 in communication with the scanning system 110 and shown in FIG. 4 as mounted on the body of the scan/print device 101 but which could be connected in a wired or wireless configuration adjacent to or remote from the body. This allows the user access to a live picture of what is in the high-resolution system 100 in what can be a low resolution image as seen in the capture zone 114. The capture zone is defined by an angle of view of the image capture device of the image. The embodiment shown in FIG. 5 has two image capture devices, each having an angle of view and together forming an angle of view that encompasses the whole platen.

The user has an active/live preview of the object on the scanner platform. This view can be low resolution and is non-archival in that it is not held in long-term memory and is not intended for long-term use as they are discarded. If there is a jam that has an unknown location a stream of non-archival images will flow at a frame rate defined as a number of frames of image per time showing the area of possible concern. In contrast the archived images are intended for long-term use and are usually a higher resolution then the non-archival images. The archived images are those intended to be used in the down stream process. The one or more capture devices 124, also referred to as an image capture modules, contain the image detector and are located in the body of the scanner, shown here as a flatbed scanner, and connecting it to an external display 130. The print scanner with jam detection unit can be adapted to engage an interface that can be used to convey images and related data to and/or from any imaging device including any electronic device having images stored therein including, but not limited to, cellular phones, personal digital assistants, personal computers, and image players.

FIG. 5 shows a portion of the print scanner with jam detection system 100 including the image-forming subsystem 112, which allows one to scan the document along with the image capture module 124. One or more light sources 126 respectively, provide the light energy necessary to illuminate images on the document and supply any light that might be needed by the modules 124. The image-forming unit traverses along an axis substantially parallel to axis Y. A translation means is provided within the enclosure and attached to the image-forming subsystem and causing it to move in a direction permitting scanning of documents placed on the glass top. The translation means can include a pulley and belt system adapted to engage the image-forming subsystem for effecting its motion and permitting platen scanning of documents placed on the glass top. A rod or rods within the enclosure can be engaged with the image-forming subsystem and guide its movement for platen scanning.

In the platen scanner shown in FIG. 5, a rod bearing, within the housing of the scanning unit 110 is provided and adapted for facilitating the motion in a direction parallel to axis Y. A drive subsystem, or other suitable translation means, comprises pulleys motor, and belts, can be used for translating the system. In this way, the scanning imaging system 112 glides along the rod in the enclosure 110 of the platen scanner 110 performing platen scanning of documents placed on a platen 104 of the scanning system 110. The image-forming subsystems can include a lens and a light source disposed about the paper pathway for directing light onto paper documents that have entered the first scanning unit through the feeder opening. Mirrors within each image-forming subsystem are configured for guiding reflected light from the paper document through the lens and onto the imaging sensor. In this way, the image-forming subsystems are able to scan a document being transported through the first scanning unit. One possible source of light is first imaging station illuminator utilizing four cylindrical fluorescent lamps arranged in a rectangular configuration and directed to illuminate and located beneath the platen 104.

### Image Capture Device

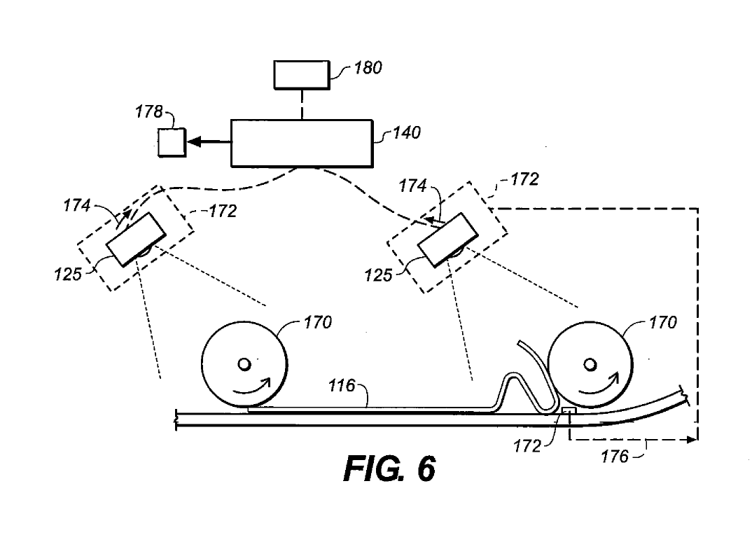

To obtain images, the one or more image capture modules that utilize the image capture device 125 as shown in FIG. 6, which is typically configured as a charge couple device (CCD) and/or a camera with a light source. The use of a CCD or other device can be paired with appropriate filtration and sensitivity capture red, green, and blue image signals from the image bearing mediums being scanned. These additional features may not be necessary since in most instances only a low-resolution image will be needed since for the non-archival images. Other forms of image sensors can be used such as those that use complimentary metal oxide, and charge injection devices to capture image information. Image information from image scanner is provided to scanner driver having appropriate driving and image processing circuits and systems of the type commonly used to convert image data from image scanner into a digital image. The scanner can, for example, contain a single camera, usually comprised of one or more CCD or CMOS arrays and supporting electronics, and a motor for moving the camera. The print scanner with jam detection system may need to have

### Control Unit

A controller 140 to control the portions of the scanning system 110 and the image capture device can include a microprocessor, micro-controller, or any other electronic circuit adapted to govern image scanning, processing, storage and sharing processes. The outputs of the image capture device, which could include a sensor, 125 as well as the linear imaging device are passed to a central processing unit, which can be part of a computer or other device. The captured digital images may be stored, transmitted and/or manipulated as desired. Typically, the captured archival digital images would be sent to a device for writing the information on to a storage medium for example, a CD or computer disk and the non-archival will be sent to the viewer. Alternatively, the data could be sent to an image storage device which could be the computer of the owner of the images, a printer for printing of the image, or simply to a long term or temporary storage device or facility whereby the archival images could be accessed at some later point in time and the non-archival can be manipulated if necessary. The control unit can include image processing. Having the image processing built into the scanner, as opposed to having the host computer do the image processing, allows for use of dedicated electronic hardware for this function, providing faster processing speeds. The image processing could include, but is not limited to, image enhancements, conversion to a grayscale or a black-and-white image, image skew correction, border removal, background form dropout, and image file compression.

### Print Engine

FIG. 4 also shows the print engine 120, also sometimes referred to as a printer 120. The print engine 120 includes a housing 152 having a print engine that applies markings or otherwise forms an image on a receiver medium, such as a document 116 within a printable area with the printable area being constrained as is known in the art by the size of the receiver medium, the type of print engine used and the type of receiver medium. Preferably, the printable area extends across all of the available space on receiver medium. The print engine can record images on receiver medium using a variety of known technologies including conventional four color offset separation printing or other contact printing, silk screening, dry electrophotography such as is used in the NexPress 2100 printer sold by Eastman Kodak Company, Rochester, N.Y., USA, thermal printing technology, drop on demand ink jet technology and continuous inkjet technology. For the purpose of the following discussions, print engine will be described as being of a type that generates color images. However, this is not necessary and the claimed methods and apparatuses can be practiced with a print engine that is adapted to form monotone images such as black and white, grayscale or sepia toned images. Medium advance is used to position the receiver medium and/or print engine relative to each other to facilitate recording of an image on receiver medium

The controller 140 discussed above can include a processor to perform a number of pre-printing operations, which can include converting digital image data into colors to be printed on receiver medium, determining a printing speed for printing using receiver medium, determining whether an image can be printed using the loaded type or shape of receiver medium, determining whether there is a need to reload the a print medium supply, selecting a dye or colorant set for use in printing using receiver medium and/or any other functions necessary to prepare data and materials for print engine 120 can record an image on receiver medium. Other examples of such pre-printing operations include determining before printing, whether printer 120 has been loaded with a desired type of print medium. Once that the pre-printing operations are complete, processor 150 can cause print engine 120 and, optionally, receiver medium transport path to operate to record an image on the printable layer using print engine. The printing can comprise any form of printing known in the art. The controller 140 and processor can also perform a number of pre-jam and jam correction operations, which can include watching for indications of a potential jam conditions, such as misplaced pare that has the wrong side up or which is skewed and correct the pre-jam condition and/or alert a user that corrective actions must be taken. Similarly the controller 140 and processor can recognize and detect current jams and perform a number of jam correction operations. Communications can be wired or non-wired as discussed above.

The image viewing system 108 of the scanner system 100 is mounted on the body as shown in FIG. 4. The linear imager 112, the linear imager being translatable relative to the platen 104 and, in this embodiment, the platen in relation to the linear imager defines the capture zone 114. The image viewing system 108 can also include a user input system 156 or other device capable of receiving an input from a user and converting this input into a form that can be used by a processor 150. For example, user input system 156 can comprise a touch screen input, a touch pad input, a 4-way switch, a 6-way switch, an 8-way switch, a stylus system, a trackball system, a joystick system, a voice recognition system, a gesture recognition system or other such systems. In the embodiment illustrated in FIG. 5 the user input system 156 includes a keypad or keyboard for receiving input from a user. The display 130 is connected to processor 150 and provides information to a user so that the user can interact with printer 120 and scanning module 110. Various components of user input system 156 and/or display 130 can be located within housing or can be separate therefrom. Where separate, user input system 156 and display 130 can exchange signals with processor 150 by way of wired or wireless signals and connections.

The image-viewing module 108 acts as the user interface with human interface features allowing a user to input information in a way that can be detected by controller 140 and the display 130 allowing the scanner module 110 to provide information to the user. Display 130 can comprise a status indicator such as a visible signal or icon, text messages, or images. In the embodiment shown in FIG. 5, the system can be used to receive signals from controller 140 and to convert these signals into a form that can be used by display 130 to present information to a user. This information includes the real time image of the item 115 on the platen 104 during scanning.

The system 100 also can include memory 158. Memory 158 can include conventional memory devices including solid state, magnetic, optical or other data storage devices. Memory 158 can be fixed within printer 120 or it can be removable. In the embodiment of FIG. 5, memory 158 is shown adjacent the processor 140. Data, such as control programs, digital images and metadata, can also be stored in a remote memory. The printer 20 can use a communication system 160 for communicating with, for example, remote memory system. Communication system 160 can be, for example, an optical, radio frequency circuit having a transducer and appropriate signal processing circuitry to convert image and other data into a form that can be conveyed to a remote device such as remote memory system by way of an optical signal, radio frequency signal or other form of signal. Communication system 160 can also be used to receive a digital image and other information from a host computer or network. Communication system 160 provides processor 140 with information and instructions from signals received thereby.

In one embodiment, a portion of which is shown in FIG. 6, the print scanner with jam detection system 100 includes one or more media transports 170 disposed in the body with the print engine disposed in the body relative to at least one of the media transports 170. The print scanner with jam detection system 100 includes one or more image capture modules 125 as part of a jam detection module 172 disposed in the body facing respective portions of the one or more media transports 170, each the image capture module generating at least one and preferably a stream of images 174 from the jam detector in order to detect any media jams or pre-jam conditions in the system including those in relation to the one or more media transports 170. The jam detector 172 can generate an error signal 176 responsive to the media jam, and a control unit can receive the streams of images 172 from the image capture modules 125 and the error signal 176 from the jam detector. In one example the control unit responds to the error signal and generates a log 178 including one of more current images from the one or more streams and/or all streams.

The log 178 can include image sequences from each of the streams so that the system the system can use a plurality of user-variable operating parameters along with the log and current values and information associated with the user-variable operating parameters, supplied as metadata associated with respective the images, to detect and correct the problem, such as a jam. Examples of user-variable operating parameters, such as temperature and humidity as well as paper type, printer mode and past information but could include any of the parameters the system and/or user monitors. The media transports can include a recirculating feeder and another of the media transports is a receiver transport. Note that if there are multiple image capture modules then the image capture modules can be interchangeable with each other.

The one or more media transports are subject to media jams in a plurality of locations in the printing system and the control unit includes an artificial intelligence component capable of generating one of a plurality of different remedial signals responsive to the error signal and the log. These artificial intelligence component includes one of more of the following, individually or in any combination: rule-based systems, theorem proving systems, semantic knowledge network approaches, frame-based knowledge systems, neural networks, fuzzy-logic based systems, genetic algorithm mechanisms, and heuristic-based systems.

A monitoring unit 180 can be wired or wireless and may be remote in some embodiments and include a first telecommunications interface, and wherein the printing system further includes a second telecommunications interface mounted to the body, the telecommunications interfaces being operatively connectable. The control and monitoring units are configured in an embodiment to selectively upload and display the log on the monitoring unit and the telecommunications interfaces each include voice communications capabilities as well as to selectively upload and display each of the streams on the monitoring unit.

In the configuration shown in FIG. 4, a user has the option of sheet-fed scanning by the insertion of documents through feeder opening, or platen scanning of documents by placement of documents over platen 104 of the platen scanner. In one embodiment, the first scanning unit includes a feeder opening similar to that shown in FIG. 1, through which paper documents can be fed for sheet-fed scanning and the above described system would be detectable and able to detect the original paper jam and respond using the controller and or the user to automatically and/or manually go through the steps necessary to correct the problem with minimum damage to the document or receiver and the machine. A feeder opening provides a means for loading documents into the scanning module 110.

Documents exit the sheet-fed scanner through exit opening. An exit opening is provided and adapted to deliver scanned documents to an output tray. A paper pathway extends from the feeder opening through the scanner to the exit opening. An image-forming subsystem is disposed within the first scanning unit and configured to scan images appearing on paper documents fed through the feeder opening and transported over the paper pathway where additional imagers, such as cameras, could be used to detect and correct any jams or pre-jam conditions as discussed above. A feed roller disposed about the feeder opening effects the introduction of documents onto the paper pathway. A separation roller or separation pad can also be employed and used to ensure that only a single sheet of paper is fed through the feeder opening at a time. The first scanning unit further includes a plurality of rollers disposed about the first paper pathway for effecting transmission of paper documents from the feeder opening to the exit opening.

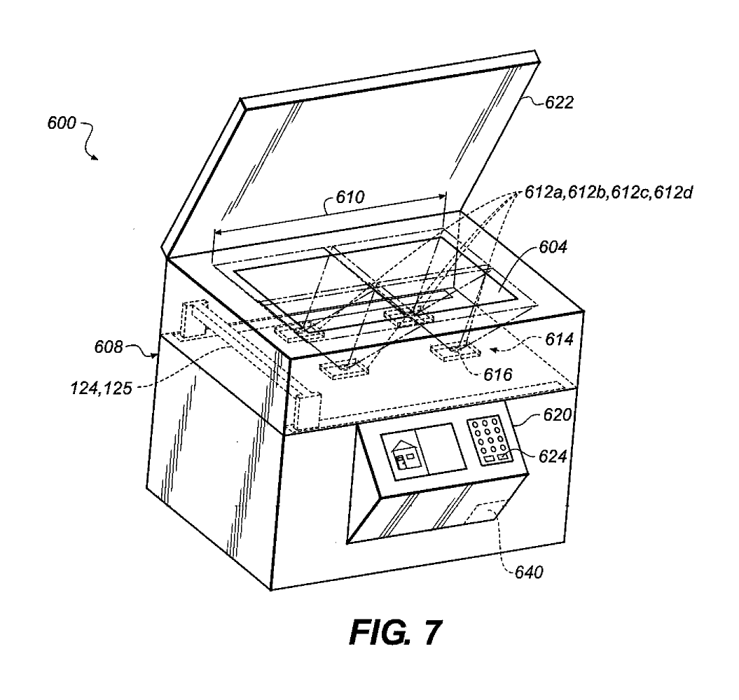

In one embodiment the scanning module shown in FIG. 7 a scanning module 600 has a transparent platen 604 mounted to the body 608, the platen defining a capture zone 610 covering the platen surface. The four image capture devices are additive to yield one capture zone as shown in FIG. 5, but could be separated and used individually if needed. The scanning modules 600 being actuatable to translate along the platen and scan while the capturing the archival image of the capture zone that can be continual or initiated as needed, such as when a valuable document is being scanned by generating an error signal from the jam detector. When the error signal is received it can be added to a log of error signals to be used by the controller and/or user to optimize operations and minimize future e problems such as jams. The jam detector allows the user to actually see the jam real time as well as the conditions that lead to the jam and thus easily initiate corrective actions.

The one or more image capture modules 612a-d are mounted in the body in fixed relation to the capture zone in the embodiment t but could also move. The one or more image capture modules 612 are operative to capture a stream of non-archival images of the capture zone. Each image capture module includes an area array imager 614a-d, the one or more image capture modules 612 being operative to output a stream of non-archival images of the capture zone using a cooperative lamp 616 mounted below the platen 604 facing the capture zone, the lamp being operative with the one or more of the image capture modules. Attached to the body is a display module 620 with a viewer 621 for receiving the stream of non-archival images from the capture modules and displaying the non-archival images in real time on the viewer 621.

The system 600 has a cover 622 movable between a first position overlaying the platen 604 and a second position spaced apart from the first position. The system 600 also has a switch 624 enabling operation of the one or more image capture modules when the cover is in the second position. The display 620 is operatively connected to the image capture device, wherein the display shows the stream of non-archival images in real time. The switch 624 is changeable between a first state disabling capture of the stream of non-archival images by the image capture device and a second state enabling the capture. The control unit 640 is used to actuate and control the system. These can be stills or image sequences and the display can be in a viewer far from the actual scanner which would allow a monitor to monitor conditions remotely, such as through a network or internet connection.

This scanning module 600 in one embodiment has a linear imager and the one or more image capture modules each include an area array imager. The one or more capture modules further include a plurality of the capture modules, each the capture module of the plurality capturing a respective image sequence of a different portion of the capture zone, the system further including the control unit for compositing the respective image sequences into the stream of non-archival images. The compositing could further include stitching concurrent frames of the image sequences together to provide the stream of non-archival images.

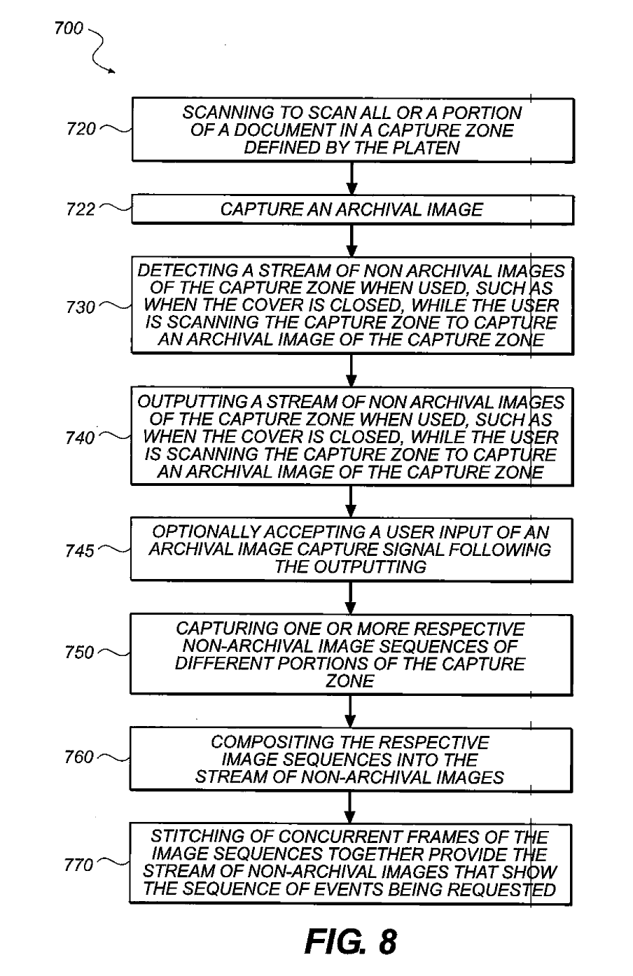

The system shown in FIG. 8 is used to scan using a scanning method 700 for the system 100 including the steps of scanning 720 a capture zone defined by the platen and capturing 722 an archival image of the capture zone wherein one or more media can be traveling though one or more media transports. Then detecting 730 and outputting 740 a stream of non-archival images of the capture zone when used, such as when the cover is in position for acceptance 745 by the user or controller while the user is scanning 720 the capture zone to capture an archival image of the capture zone. The method wherein the outputting further includes operating one or more image capture modules mounted in fixed relation to the capture zone defined by the platen, each the capture module having an area array imager

While capturing 750 the archival image using a linear imager a plurality of image capture modules can capture module capturing one or more respective non archival image sequences of a different portions of the capture zone and composite 760 the respective image sequences into the stream of non-archival images. Further stitching 770 of concurrent frames of the image sequences together provide the stream of non-archival images that show the sequence of events being requested.

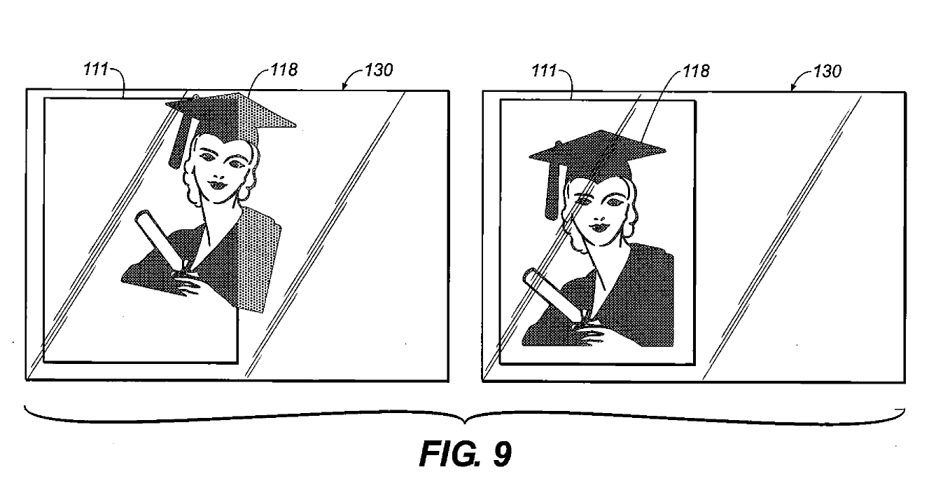

The print scanner with jam detection system 100 also shows a border view of the previewed image 118, as it would appear as in the non-archival image form 111. This system can then communicate to the user what the expected output would be if a full scan were initiated with the object in that position as shown in FIG. 9. Once the user is satisfied that all the desired material is inside the border a high-resolution scan may then be initiated. In one example when the user has moved the physical image around on the platen to achieve the desired composition, the user may change the displayed border to whatever size the printer can output (4×6, 8.5×11, 8.5×14 etc. . . . Similarly the user can choose the border to display portrait or landscape

It is also possible to get similar results in some instances may be obtained by manipulating the border displayed on the LCD device itself such as grabbing the border by means of a touch screen and positioning it on the previewed image instead of moving the physical material that is to be scanned.

### Operation

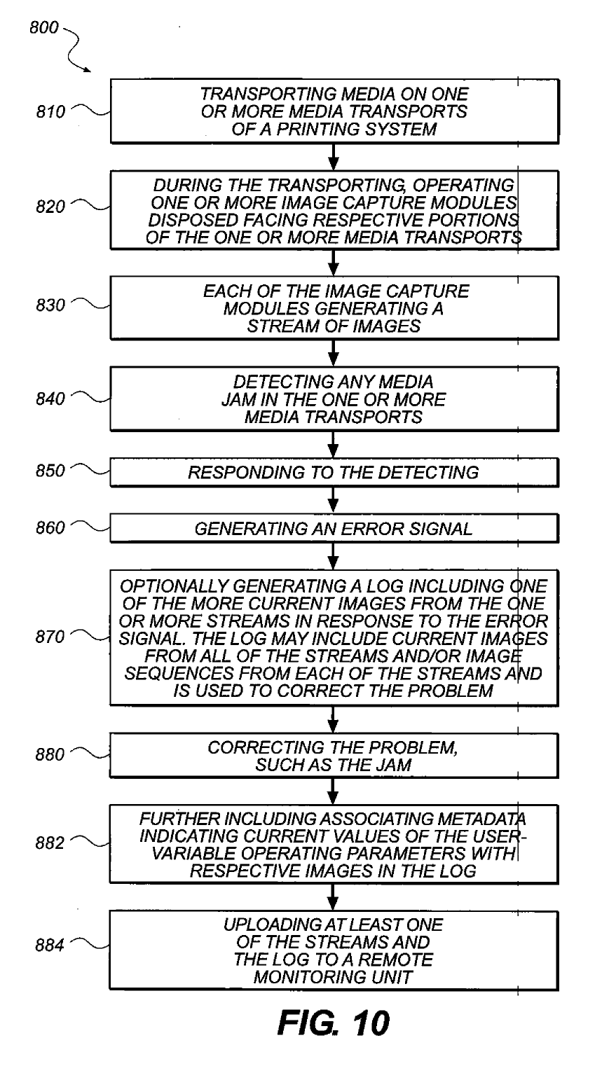

The jam detection system shown in FIG. 10 is used when a jam is detected or predicted in most situations but would be applicable to any problem that can be aided by a visual inspection and/or log as supplied by one or more image detectors. The method 800 includes the steps of the steps of transporting 810 media on one or more media transports of a printing system, during the transporting operating 820 one or more image capture modules disposed facing respective portions of the one or more media transports, each the image capture module generating 830 a stream of images. Then detecting 840 any media jam in the one or more media transports and responding 850 to the detecting by generating an error signal 860 and optionally generating a log 870 including one of more current images from the one or more streams in response to the error signal. The log may include current images from all of the streams and/or image sequences from each of the streams and is used to correct the problem 880, such as the jam. The method further includes associating metadata indicating current values of the user-variable operating parameters with respective the images in the log 882 and uploading 884 at least one of the streams and the log to a remote monitoring unit. It is clear that this method would also be applicable to other areas of operations that have problems detectable by visual inspections that an image detector could make but an operator would not be able to observe without the aid of the image detector as described herein. When the control unit has memory temporarily storing the streams and indefinitely storing the log and a display selectively showing the streams of images in real time.

A user of scanner module in the manual configuration manually positions upper scanner module at an edge of an area of image bearing medium to be scanned, and manually advances the upper scanner module across the area to be scanned along a first path. Where the area to be scanned is wider than the maximum scanner width, the upper scanner module can be returned to a start position and manually scanned along other scan paths of the medium until all portions of image bearing medium have been scanned. This can be done, for example, to enable scanning of oversized images or to allow scanning of oversized images, or to allow scanning of a scanning area that incorporates the entire image bearing medium such as to capture an image of an entire scrapbook page. In this example, the user of upper scanner module manually guides the upper scanner module over the wider media in a series of overlapping sections, which will be digitally “stitched” by the microprocessor. In this way upper scanner module can be dragged over image bearing medium by the user and feedback from the un-powered drive motor can be used to determine the scanner position and rate of movement. Alternatively, scanner module can be used to obtain images of only a portion of image bearing mediums.

The invention has been described in detail with particular reference to certain preferred embodiments thereof, but it will be understood that variations and modifications can be effected within the spirit and scope of the invention.

1. A printing system comprising:
a body;
one or more media transports disposed in said body;
a print engine disposed in said body in operative relation to at least one of said media transports;
one or more image capture modules disposed in said body facing respective portions of said one or more media transports, each said image capture module generating a stream of images;
a jam detector detecting any media jam in said one or more media transports, said jam detector generating an error signal responsive to said media jam; and
a control unit receiving said streams of images from said image capture modules and said error signal from said jam detector, said control unit responsive to said error signal, generating a log including one of more current images from said one or more streams.

2. The system of claim 1 wherein said log includes current images from all of said streams.

3. The system of claim 2 wherein said log includes image sequences from each of said streams.

4. The system of claim 1 wherein said printing system has a plurality of user-variable operating parameters and said log also has current values of said user-variable operating parameters as metadata associated with respective said images.

5. The system of claim 1 wherein said control unit has memory temporarily storing said streams and indefinitely storing said log and a display selectively showing said streams of images in real time.

6. The printing system of claim 3 further comprising a monitoring unit remote from said body, said monitoring unit including a first telecommunications interface, and wherein said printing system further comprises a second telecommunications interface mounted to said body, said telecommunications interfaces being operatively connectable.

7. The printing system of claim 6 wherein said control and monitoring units are configured to selectively upload and display said log on said monitoring unit and said telecommunications interfaces each include voice communications capabilities.

8. The printing system of claim 7 wherein said control and monitoring units are configured to selectively upload and display each of said streams on said monitoring unit.

9. The printing system of claim 1 wherein at least one of said image capture modules includes an illumination source.

10. The printing system of claim 1 wherein said image capture modules are interchangeable with each other.

11. The printing system of claim 1 wherein said one or more media transports are subject to media jams in a plurality of locations in said printing system and said control unit includes an artificial intelligence component capable of generating one of a plurality of different remedial signals responsive to said error signal and said log.

12. The printing system of claim 11 wherein said artificial intelligence component includes one of more of the following, individually or in any combination: rule-based systems, theorem proving systems, semantic knowledge network approaches, frame-based knowledge systems, neural networks, fuzzy-logic based systems, genetic algorithm mechanisms, and heuristic-based systems.

13. The printing system of claim 1 wherein one of said media transports is a recirculating feeder and another of said media transports is a receiver transport.

14. A printing method comprising the steps of:
transporting media on one or more media transports of a printing system;
during said transporting, operating one or more image capture modules disposed facing respective portions of said one or more media transports, each said image capture module generating a stream of images;
detecting any media jam in said one or more media transports;
responsive to said detecting, generating an error signal; and
responsive to said error signal, generating a log including one of more current images from said one or more streams.

15. The method of claim 14 wherein said log includes current images from all of said streams.

16. The method of claim 15 wherein said log includes image sequences from each of said streams.

17. The method of claim 14 wherein said generating further comprises associating metadata indicating current values of said user-variable operating parameters with respective said images in said log.

18. The method of claim 14 further comprising uploading at least one of: said streams and said log, to a remote monitoring unit.
